(19) United States
(12) Patent Application Publication
(10) Pub. No.: US 2026/0067572 A1
(43) Pub. Date: Mar. 5, 2026

(54) SHAKE CORRECTION DEVICE, IMAGING APPARATUS, OPTICAL DEVICE, AND DRIVING DEVICE

(71) Applicant: FUJIFILM Corporation, Tokyo (JP)

(72) Inventors: Yu MOCHIZUKI, Saitama (JP); Yuta ABE, Saitama (JP); Kouhei AWAZU, Saitama (JP); Motomu SHIBASAKI, Saitama (JP)

(73) Assignee: FUJIFILM Corporation, Tokyo (JP)

(21) Appl. No.: 19/310,865

(22) Filed: Aug. 26, 2025

(30) Foreign Application Priority Data
Aug. 30, 2024 (JP) 2024-150088

(51) Int. Cl. H04N 23/68

(52) U.S. Cl. CPC H04N 23/687

(57) ABSTRACT

An aspect of the present invention provides a shake correction device, an imaging apparatus, an optical device, and a driving device. A shake correction device according to an aspect of the present invention is a shake correction device including a fixing unit, a movable unit, and a plurality of balls disposed between the fixing unit and the movable unit, in which the movable unit is movable in contact with the plurality of balls, a first magnet member, a first non-magnetic member, and a first member including a magnetic member are disposed with respect to a first ball that is at least one ball of the plurality of balls, and the first non-magnetic member and the first magnet member are disposed in order, to face the first member with the first ball interposed therebetween.

### CROSS-REFERENCE TO RELATED APPLICATION

The present application claims priority under 35 U.S.C § 119(a) to Japanese Patent Application No. 2024-150088 filed on Aug. 30, 2024, which is hereby expressly incorporated by reference, in its entirety, into the present application.

### BACKGROUND OF THE INVENTION

### 1. Field of the Invention

The present invention relates to a shake correction device, an imaging apparatus, an optical device, and a driving device, and particularly to a configuration for biasing a movable unit to a fixing unit.

### 2. Description of the Related Art

Regarding the shake correction device, for example, JP7371131B describes a configuration in which a magnet is provided in a ball receiving portion. In addition, JP2021-140081A describes that a magnetic circuit is configured by a fixing unit, a magnet, a coil, and a top yoke.

### SUMMARY OF THE INVENTION

An embodiment according to a technology of the present disclosure provides a shake correction device, an imaging apparatus, an optical device, and a driving device.

A shake correction device according to a first aspect of the present invention is a shake correction device comprising a fixing unit, a movable unit, and a plurality of balls disposed between the fixing unit and the movable unit, in which the movable unit is movable in contact with the plurality of balls, a first magnet member, a first non-magnetic member, and a first member including a magnetic member are disposed with respect to a first ball that is at least one ball of the plurality of balls, and the first non-magnetic member and the first magnet member are disposed in order, to face the first member with the first ball interposed therebetween.

In a shake correction device according to a second aspect of the present invention, in the first aspect, the first non-magnetic member, the first magnet member, and a yoke are provided in order.

In a shake correction device according to a third aspect, in the first or second aspect, the fixing unit includes the first magnet member, the first non-magnetic member is provided between the first magnet member and the first ball, and the movable unit includes the first member.

In a shake correction device according to a fourth aspect, in the first or second aspect, the movable unit includes the first magnet member, the first non-magnetic member is provided between the first magnet member and the first ball, and the fixing unit includes the first member.

In a shake correction device according to a fifth aspect, in any one of the first to fourth aspects, the first member includes a first magnetic member and a holding member that holds the first magnetic member, and the first ball is in contact with the first magnetic member.

In a shake correction device according to a sixth aspect, in the fifth aspect, the first non-magnetic member is disposed between the first magnet member and the first ball, the first magnetic member is disposed to face the first non-magnetic member with the first ball interposed therebetween, and a second magnetic member is provided on a side opposite to the first ball with respect to the first magnetic member.

In a shake correction device according to a seventh aspect, in any one of the first to fourth aspects, the first non-magnetic member is disposed between the first magnet member and the first ball, and the first member includes a second non-magnetic member disposed to face the first non-magnetic member with the first ball interposed therebetween, and a second magnetic member disposed on a side opposite to the first ball with respect to the second non-magnetic member.

In a shake correction device according to an eighth aspect, in the seventh aspect, the first member includes a second magnet member, the second magnet member is disposed on a side opposite to the first ball with respect to the second non-magnetic member, and the first ball is in contact with the second non-magnetic member.

In a shake correction device according to a ninth aspect, in any one of the first to eighth aspects, a ball holding part that holds the first ball is formed in the movable unit or the fixing unit.

An imaging apparatus according to a tenth aspect comprises the shake correction device according to any one of the first to ninth aspects, and an imaging element held by the movable unit, in which the movable unit is driven in a plane intersecting an optical axis of the imaging element to correct an image shake. In the tenth aspect, the term “in a plane intersecting an optical axis of the imaging element” may refer to being in a plane perpendicular to the optical axis of the imaging element, but the present invention is not limited thereto.

An imaging apparatus according to an eleventh aspect comprises an imaging element, the shake correction device according to any one of the first to ninth aspects, and a shake correction optical system held by the movable unit, in which the movable unit is driven in a plane intersecting an optical axis of the shake correction optical system to correct an image shake. In the eleventh aspect, the term “in a plane intersecting an optical axis of the shake correction optical system” may refer to being in a plane perpendicular to the optical axis of the shake correction optical system, but the present invention is not limited thereto.

An optical device according to a twelfth aspect comprises the shake correction device according to any one of the first to ninth aspects, and a shake correction optical system held by the movable unit, in which the movable unit is driven in a plane intersecting an optical axis of the shake correction optical system to correct an image shake.

A driving device according to a thirteenth aspect is a driving device comprising a fixing unit, a movable unit, and a ball disposed between the fixing unit and the movable unit, in which the movable unit is movable in contact with the ball, a first magnet member, a first non-magnetic member, and a first member including a magnetic body are disposed with respect to the ball, and the first non-magnetic member and the first magnet member are disposed in order, to face the first member with the ball interposed therebetween.

### BRIEF DESCRIPTION OF THE DRAWINGS

FIG. 1 is a view showing a schematic configuration of an imaging apparatus according to a first embodiment.

FIG. 2 is a block diagram showing an aspect of an internal configuration of the imaging apparatus.

FIGS. 3A and 3B are perspective views showing disposition of a ball receiving surface in a shake correction device.

FIG. 4 is a sectional view showing a configuration example of a magnetic spring.

FIGS. 5A and 5B are views showing a configuration for biasing a movable unit to a fixing unit.

FIG. 6 is another sectional view showing the configuration example of the magnetic spring.

FIG. 7 is still another sectional view showing the configuration example of the magnetic spring.

FIG. 8 is still another sectional view showing the configuration example of the magnetic spring.

FIG. 9 is still another sectional view showing the configuration example of the magnetic spring.

FIG. 10 is still another sectional view showing the configuration example of the magnetic spring.

FIG. 11 is a view showing a configuration example of a ball holding part.

FIG. 12 is still another sectional view showing the configuration example of the magnetic spring.

FIGS. 13A to 13D are views showing examples of flow of a magnetic flux.

FIG. 14 is a view showing a schematic configuration of an imaging apparatus according to a second embodiment.

### DESCRIPTION OF THE PREFERRED EMBODIMENTS

### Biasing of Movable Unit in Shake Correction Device

As a measure against the shake of the image due to the camera shake, a camera equipped with an in-body image stabilizer (IBIS, also referred to as a BIS), which drives and corrects the imaging element, has been increasing. As a component of the IBIS, a drive actuator (voice coil motor (VCM)) may be used, and as a configuration of the VCM, a one-side configuration in which a magnet is disposed on one side (upper side or lower side in the optical axis direction) and a double magnet configuration in which a magnet is disposed on both sides up and down with a coil interposed therebetween to increase thrust force are known.

Since the IBIS is configured with a movable unit and a fixing unit, it is necessary to bias the movable unit to the fixing unit side (mount surface side) in order to stabilize the imaging surface. As the biasing method, either “a configuration in which a movable unit and a fixing unit are connected by a coil spring” or “a configuration in which a plate of a magnetic body is disposed on a flexible printed circuit (FPC) in an upper portion of a VCM magnet” is often employed.

Which of the two configurations is selected is greatly affected by the weight of the movable object and the configuration of the VCM. The advantage of the configuration in which the magnetic plate is disposed in the upper portion of the FPC is that “since the magnet in the configuration of the VCM is used, it is not necessary to additionally place the components at other places in the VCM projection direction (for example, the optical axis direction)”. Meanwhile, in the double magnet configuration in which the distance between the magnet and the FPC is close, the plate is attracted to the magnet, and thus this configuration cannot be used. A configuration is also known in which a magnetic plate is provided inside a coil to capable of introducing a magnetic spring even in a double magnet, but since the magnetic plate is drawn in opposite directions by magnets on both sides, it is necessary to consider the vertical offset, and since the magnetic plate needs to fit in an inner diameter of the coil, a constraint condition on the size and position of the magnetic plate is considerably stricter than in the case of the one-side magnet configuration.

In such a case or in a case where a larger biasing force is required, a configuration in which a coil spring provided between the movable unit and the fixing unit is used is used. This configuration has an advantage in that a biasing force can be determined only by the coil spring regardless of the VCM magnet and a place can be freely disposed because it is not dependent on the VCM magnet. Meanwhile, since the coil spring requires a spring hook (hooking portion), a space exclusively for the coil spring is separately required in both the fixing unit and the movable unit. In addition, since the shape of the spring hook is complicated, the material of the fixing unit and the movable unit is also limited.

In view of such circumstances, the inventors of the present application conducted extensive studies and obtained the idea of the present invention described below. Hereinafter, preferred embodiments of a shake correction device, an imaging apparatus, an optical device, and a driving device according to the present invention will be described with reference to the accompanying drawings. In the following drawings, in order to make the description easier to understand, depending on the drawings, some members may not be shown, and/or members may be shown with changes in color, line types, or the like. In addition, the drawings do not necessarily accurately show the shape and dimensions of each member.

### First Embodiment

### Configuration of Imaging Apparatus

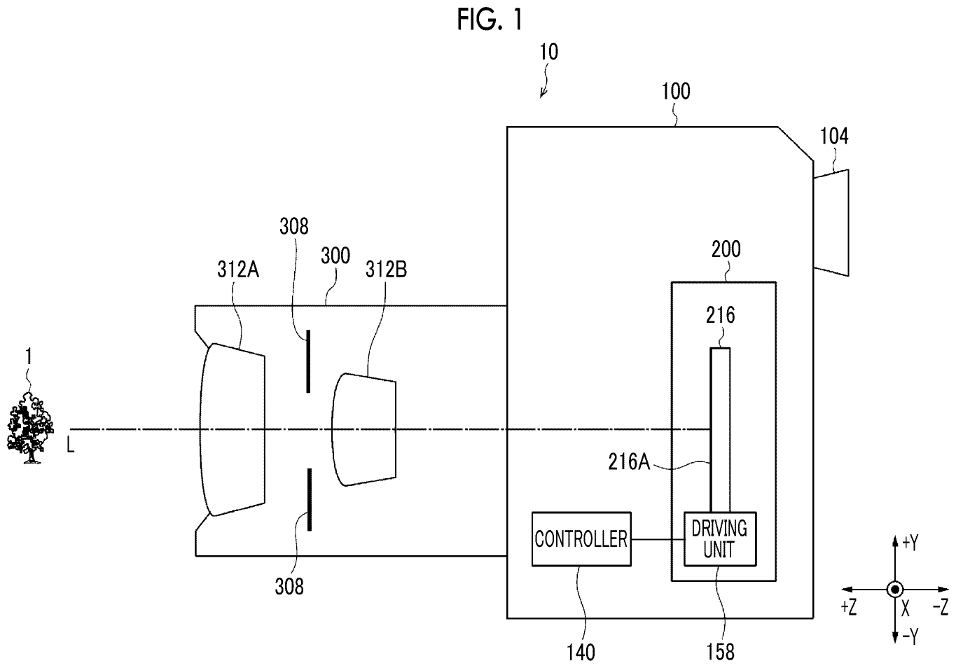

First, an imaging apparatus equipped with a shake correction device will be described. FIG. 1 is a view showing a schematic configuration of an imaging apparatus according to a first embodiment.

An imaging apparatus 10 (imaging apparatus) is a digital camera, and a lens device 300 (optical system) is mounted on an imaging apparatus main body 100. The lens device 300 may be integrated with the imaging apparatus main body 100 or may be attachable and detachable to and from the imaging apparatus main body 100. The lens device 300 comprises a stop 308, a lens group 312A, and a lens group 312B, and has an optical axis L (optical axis). The lens device 300 forms an optical image of a subject 1 on an imaging element 216. The imaging apparatus main body 100 comprises an eyepiece portion 104, and an imager can place his/her eye on the eyepiece portion 104 to visually recognize the subject 1.

On the imaging element 216, an imaging surface 216A (imaging surface; light-receiving surface) is disposed along a plane (XY plane) formed by two directions (X direction and Y direction) perpendicular to the optical axis L (Z direction). The imaging element 216 is held by a movable unit of a shake correction device 200 (shake correction device, driving device). Further, as will be described in detail below, a shake correction function is realized by a controller 140 controlling a driving unit 158 included in the shake correction device 200.

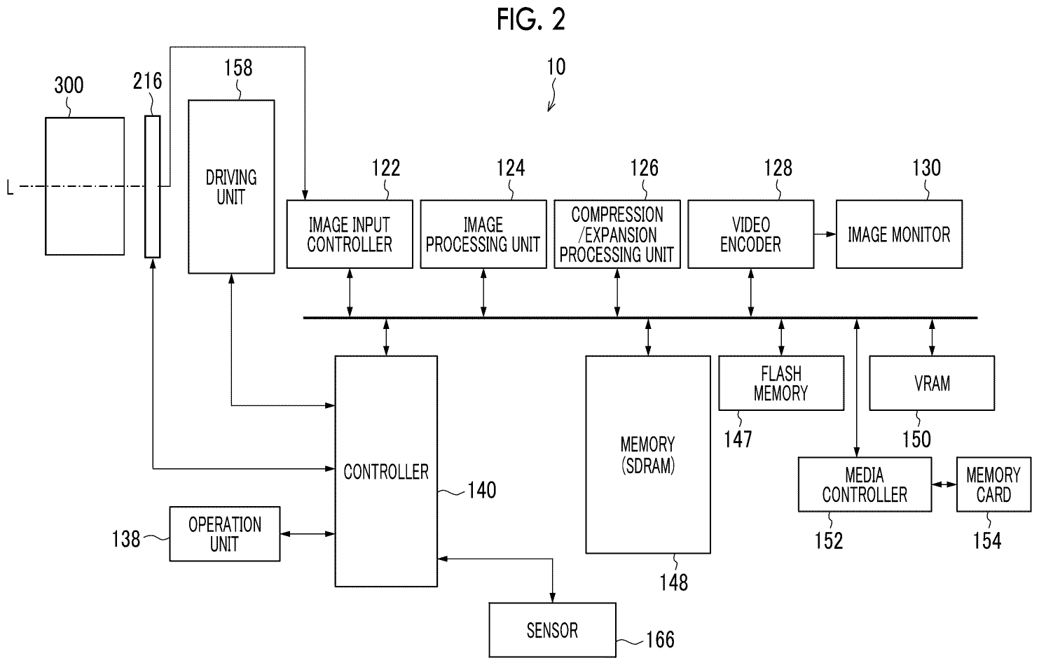

FIG. 2 is a block diagram showing an aspect of an internal configuration of the imaging apparatus 10. The imaging apparatus 10 records a captured image in a memory card 154, and an operation of the entire apparatus is comprehensively controlled by the controller 140 comprising a processor such as a central processing unit (CPU). In addition, power is supplied from a power source (not shown) to each unit of the imaging apparatus 10.

The imaging apparatus 10 is provided with an operation unit 138, such as a shutter button, a power/mode switch, a mode dial, and a cross operation button. A signal (command) from the operation unit 138 is input to the controller 140, and the controller 140 controls each circuit of the imaging apparatus 10 based on the input signal to perform drive control of the imaging element 216, lens drive control, stop drive control, imaging operation control, image processing control, recording/reproduction control of image data, display control of an image monitor 130, and the like.

A luminous flux that has passed through the lens device 300 is imaged on the imaging element 216 (imaging element) which is a complementary metal-oxide semiconductor (CMOS) type color image sensor. The imaging element 216 is not limited to the CMOS type, and another type of image sensor, such as a charge coupled device (CCD) type or an organic imaging element, may be used.

In the imaging element 216, a large number of light-receiving elements (for example, photodiodes) are two-dimensionally arranged, and a subject image formed on the light-receiving surface of each light-receiving element is converted (photoelectrically converted) into a signal voltage (or charge) of an amount corresponding to an amount of incidence rays, and is converted into a digital signal via an analog/digital (A/D) converter in the imaging element 216 to be output.

An image signal (image data) read from the imaging element 216 in a case of capturing a motion picture or a still picture is temporarily stored in a memory 148 (for example, a synchronous dynamic random access memory (SDRAM)) via an image input controller 122.

Further, a flash memory 147 stores various parameters and tables used for a camera control program, image processing, and the like. The flash memory 147 is an example of a non-transitory and tangible computer-readable medium.

A sensor 166 is a camera shake sensor and detects posture information and posture change information of the imaging apparatus 10. The sensor 166 is configured of, for example, a gyro sensor. The sensor 166 is configured of, for example, two gyro sensors to detect a camera shake amount in a vertical direction (+Y, −Y direction) and a camera shake amount in a horizontal direction (+X, −X direction), and the detected camera shake amount (angular velocity) is input to the controller 140. The controller 140 performs shake correction by controlling the driving unit 158 to move the imaging element 216 such that the movement of the subject image corresponding to the camera shake is canceled. A gyro sensor for detecting a camera shake amount in a rotation direction (for example, around a Z axis) may be provided in the sensor 166, and the shake correction may be performed to cancel the camera shake in the rotation direction.

The driving unit 158 (drive mechanism) is controlled by the controller 140. The driving unit 158 is composed of a voice coil motor (VCM) or the like described below.

An image processing unit 124 reads unprocessed image data that is acquired via the image input controller 122 in a case of capturing a motion picture or a still picture and temporarily stored in the memory 148. The image processing unit 124 performs offset processing, pixel interpolation processing (interpolation processing for a phase-difference detecting pixel, a defective pixel, and the like), white balance correction, gain control processing including sensitivity correction, gamma-correction processing, synchronization processing (also called “demosaicing”), brightness and color difference signal generation processing, edge enhancement processing, color correction, and the like on the read image data. The image data that is processed by the image processing unit 124 and is processed as a live view image is input to a video random access memory (VRAM) 150.

The image data read from the VRAM 150 is encoded by a video encoder 128 and output to the image monitor 130 provided on a rear surface of the camera. Accordingly, the live view image showing the subject image is displayed on the image monitor 130.

The image data that is processed by the image processing unit 124 and is processed as a still picture or motion picture for recording (brightness data (Y) and color difference data (Cb), (Cr)) is stored again in the memory 148.

A compression/expansion processing unit 126 performs compression processing on the brightness data (Y) and the color difference data (Cb), (Cr) processed by the image processing unit 124 and stored in the memory 148 in a case of recording a still picture or a motion picture. The compressed image data is recorded in the memory card 154 via a media controller 152.

Further, the compression/expansion processing unit 126 performs expansion processing on the compressed image data obtained from the memory card 154 via the media controller 152 in a playback mode. The media controller 152 performs recording, reading, or the like of the compressed image data to and from the memory card 154.

### Configuration of Controller

In the first embodiment, the controller 140 may be configured by one or a plurality of pieces of hardware, and the type of hardware is not limited. For example, the controller 140 may be configured with hardware such as a central processing unit (CPU), a micro processing unit (MPU), a programmable logic device such as a field programmable gate array (FPGA), a dedicated circuit for executing specific processing, such as an application specific integrated circuit (ASIC), a graphic processing unit (GPU), neural processing unit (NPU), or the like. In addition, the controller 140 has each unit or each means that executes various types of processing in the present embodiment. In addition, the types of hardware may be a combination of different types of hardware. In a case where a plurality of pieces of hardware are configured to execute one or a plurality of pieces of processing of a certain processor, the plurality of pieces of hardware may be present in devices physically separated from each other, or may be present in the same device. In addition, in any of the embodiments, the order of each processing by the processor is not particularly limited and may be changed as appropriate. The hardware is configured by an electric circuit (circuitry) in which circuit elements such as semiconductor elements are combined, and the like.

Further, in the present embodiment, the controller 140 may be realized by hardware, software, firmware, microcode, or a combination thereof. The software, the firmware, and the microcode are configured by a program. In addition, the program may be, for example, a program module group, and each function thereof may be realized by a processor configured to execute each function. The program may be a program code or a plurality of code segments stored in one or a plurality of non-transitory and tangible computer-readable media (for example, a storage medium or other storage; may be the flash memory 147 (the same applies hereinafter)). The program may be divided and stored in a plurality of non-transitory and tangible computer-readable media existing in devices physically separated from each other. The program code or the code segment may represent any combination of a procedure, a function, a subprogram, a routine, a subroutine, a module, a software package, a class, or an instruction, a data structure, or a program statement. The program code or the code segment may be connected to another code segment or a hardware circuit by transmitting and receiving information, data, an argument, a parameter, or a content of a memory.

In the present embodiment, the “non-transitory and tangible computer-readable medium” does not include a non-tangible recording medium such as a carrier wave signal or a propagation signal itself. The controller 140 can use the memory 148 as a temporary storage region or a work region in a case of processing using a program.

In addition, the controller 140 and the image processing unit 124 may comprise various types of artificial intelligence (AI). Such AI may be, for example, AI that performs shake correction control or various types of image processing. These types of AI can also be realized by hardware, software, firmware, microcode, or a combination thereof as described above.

### Overall Configuration of Shake Correction Device

The shake correction device 200 (shake correction device, driving device) according to the first embodiment comprises a fixing unit, a movable unit, and a plurality of balls disposed between the fixing unit and the movable unit, as will be described below, and the movable unit is movable in contact with the plurality of balls.

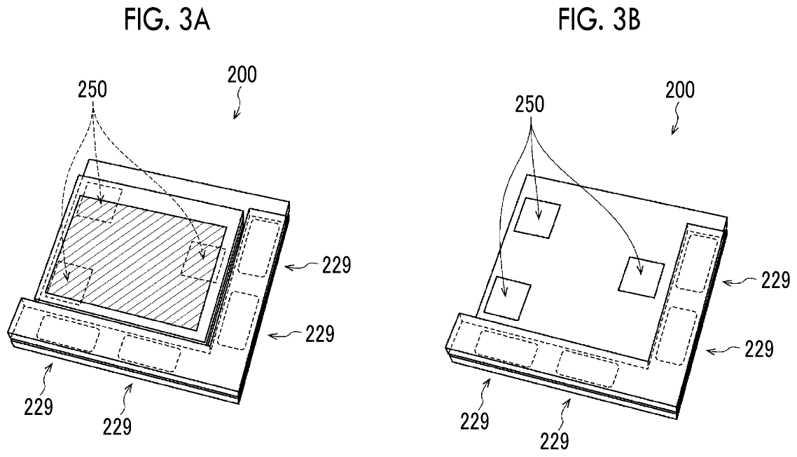

FIGS. 3A and 3B are perspective views (a state of being viewed from a +Z direction) showing disposition of a ball receiving surface in the shake correction device 200. FIG. 3A shows a state in which a region (hatched portion) in which the imaging element 216, a holding member thereof, and the like are disposed is shown, and FIG. 3B shows a state in which a region in which the imaging element 216 is disposed is omitted. As shown in FIGS. 3A and 3B, the shake correction device 200 has three ball receiving surfaces 250. Each ball (one of the “plurality of balls” including the first ball) is in contact with the ball receiving surface 250, and the ball rolls on the ball receiving surface 250. The movable unit holding the imaging element 216 is supported to be movable in a plane intersecting the optical axis L, and the shake correction device 200 can correct an image shake by the movement of the movable unit. Note that “the plane intersecting the optical axis L” is preferably a plane (XY plane) perpendicular to the optical axis L, but may not be completely perpendicular. As will be described in detail later, one surface (for example, one surface of the magnetic plate or the magnetic base) of the first member including the magnetic member is the ball receiving surface 250.

In addition, the shake correction device 200 includes a VCM 229. The VCM 229 is a mechanism for driving the movable unit in the XY plane (an example of the “plane intersecting the optical axis L”), and has a magnet and a coil. For example, the magnet is disposed in the fixing unit, and the coil is disposed in the movable unit. The number and disposition of the VCMs 229 are not limited to the aspect shown in FIGS. 3A and 3B.

### Biasing of Movable Unit by Magnetic Spring

In the shake correction device 200, the movable unit is biased to the fixing unit by the magnetic spring in a portion of the ball receiving surface. An example of a specific configuration of the magnetic spring will be described below. In the following description, although the shake correction devices (configuration example (parts 1 to 7)) having different configurations of the magnetic springs are referred to as shake correction devices 201 to 207, these shake correction devices may be collectively referred to as the “shake correction device 200”.

### Configuration Example (Part 1) of Shake Correction Device

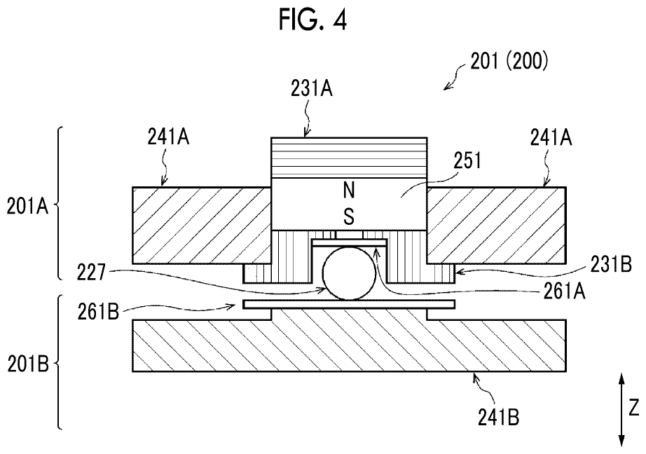

FIG. 4 is a sectional view showing the configuration example (part 1) of the shake correction device. The vertical direction of the drawing is the +Z direction (a direction parallel to the optical axis L). In the shake correction device 201 (shake correction device, driving device) shown in FIG. 4, a first magnet member 251 (first magnet member), a non-magnetic plate 261A (first non-magnetic member), and a magnetic plate 261B (magnetic member, first magnetic member, first member) are disposed with respect to a ball 227 (ball, first ball). The magnetic plate 261B is disposed on one side (lower side in FIG. 4) of the ball 227, and the non-magnetic plate 261A (first non-magnetic member) and the first magnet member 251 (first magnet member) are disposed in order, to face the magnetic plate 261B with the ball 227 interposed therebetween (on upper side in FIG. 4). In addition, the shake correction device 201 has the non-magnetic plate 261A (first non-magnetic member), the first magnet member 251 (first magnet member), and a first yoke 231A (yoke) in this order (from the lower side to the upper side in FIG. 4).

The magnetic plate 261B (first magnetic member, first member) is held by a holding member 241B (holding member). In addition, a holding member 241A and the first yoke 231A hold the first magnet member 251, and a second yoke 231B holds the non-magnetic plate 261A.

The ball 227 (first ball) can be in contact with the upper side (+Z side or −Z side) surface of the magnetic plate 261B (first magnetic member) in FIG. 4, and this surface can be the ball receiving surface. The ball 227 is also in contact with the lower side (−Z side or +Z side) surface of the non-magnetic plate 261A in FIG. 4.

### Configuration of Magnetic Spring in Ball Holding Part

In recent years, a large imaging element has been used in a digital camera, and thus a force required for driving the imaging element for shake correction has also increased. Therefore, a double magnet configuration may be employed in the VCM, but as described above, in a case where the coil position and the magnet position are close to each other, the plate may be attracted to the magnet.

Meanwhile, since the IBIS moves the imaging element, for example, three portions are held by balls. The imaging surface can follow the shake by the balls rolling smoothly, and the shake can be corrected. In a case where the ball is present between the plates and is in contact with the plates, the plates disposed to face the balls are not in contact with each other even in a case where a force is applied and the imaging surface is inclined.

Therefore, as in the invention of the present application, in a case of a configuration in which a magnet is disposed at a ball holding place, a magnetic member (magnetic plate 261B in the example of FIG. 4) is disposed on one side of a ball (first ball), and a non-magnetic member (non-magnetic plate 261A in the example of FIG. 4) is disposed on the other side of the ball to apply a magnetic biasing force, the plate is not attracted to the magnet, and even in consideration of a flat space, the space is the ball holding part (ball receiving part) necessary for movement, and thus another space is not required as in a case of using a coil spring.

The rolling surface in contact with the ball 227 needs to satisfy standards such as hardness, flatness, and surface roughness, and it is difficult to substitute the rolling surface with the magnet surface (in the example of FIG. 4, the surface of the first magnet member 251). In addition, in a case where a plate having strong magnetism is disposed in the vicinity of the first magnet member 251 (directly below the first magnet member 251 in the example of FIG. 4), the magnetic flux rotates in the plate, and thus the facing side (the side of the magnetic plate 261B; a portion to which the biasing force is originally desired to be applied) with the ball 227 interposed therebetween cannot be attracted.

Therefore, by providing the non-magnetic plate 261A as a rolling surface as in the example of FIG. 4 instead of directly using the magnet surface of the first magnet member 251 as a rolling surface, it is possible to satisfy the requirement for the rolling surface and suppress the influence on the magnetic flux. In order to suppress the influence on the magnetic flux, it is preferable that the rolling surface on the first magnet member 251 side is a non-magnetic member such as the non-magnetic plate 261A, but the rolling surface does not have to be a complete non-magnetic member. Meanwhile, in order to constitute the magnetic spring, the rolling surface on the first magnet member 251 side (upper side of FIG. 4; non-magnetic plate 261A) has weaker magnetism than the rolling surface on the opposite side with the ball 227 interposed therebetween (magnetic plate 261B in the example of FIG. 4; lower side of FIG. 4).

In addition, as shown in FIG. 4, the non-magnetic plate 261A, the first magnet member 251, and the first yoke 231A are provided in order (from the lower side to the upper side in FIG. 4) on one side (the upper side in FIG. 4; the +Z direction or the −Z direction) of the ball 227. With such a configuration, a magnetic force (magnetic flux) can be guided in the direction of the ball 227.

The first yoke 231A and the second yoke 231B can be formed of a magnetic material, and thus, an effect of guiding a magnetic force in the direction of the ball 227 and flowing (rotating) the magnetic flux can be enhanced (the same applies to a shake correction device of another form to be described below).

In the shake correction device 200 (shake correction device, driving device) according to the first embodiment, it is sufficient that at least one of the three ball receiving surfaces 250 has the configuration as shown in FIG. 4, and both the configuration as shown in FIG. 4 and the configuration of the ball holding part in the related art may be included. Preferably, all of the three ball receiving surfaces 250 of the shake correction device 200 have the configuration as shown in FIG. 4.

The ball used in the configuration according to the present invention as shown in FIG. 4 may be referred to as the “first ball”. The same applies to other configuration examples of the shake correction device according to the embodiment of the present invention, which will be described below.

In addition, in the configuration (the shake correction device and the driving device) according to the present invention, the disposition direction of the magnet member (which direction is the N pole and which direction is the S pole) is not limited to the illustrated example and may be appropriately changed. The same applies to the following configuration examples described later. Meanwhile, in a case of a configuration in which a plurality of magnet members are used, it is assumed that the disposition direction in which the magnetic circuit is appropriately configured by the plurality of magnet members is used.

### Biasing of Movable Unit in Shake Correction Device

In the example of FIG. 4, either the upper portion or the lower portion of the shake correction device 201 may be the movable unit or the fixing unit. Hereinafter, the ball 227 and the members (the second yoke 231B, the non-magnetic plate 261A, the first magnet member 251, the first yoke 231A, and the holding member 241A) above the ball 227 will be referred to as an “upper structure 201A” for convenience, and the members (the magnetic plate 261B and the holding member 241B) below the ball 227 will be referred to as a “lower structure 201B” for convenience. The upper structure 201A may be on the +Z side (subject side), or the lower structure 201B may be on the +Z side.

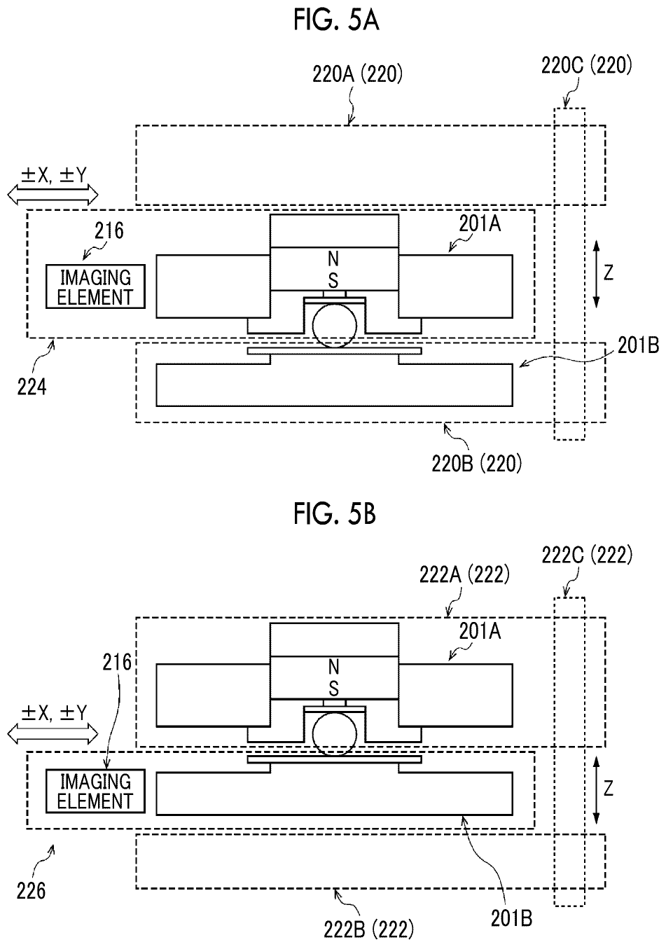

FIGS. 5A and 5B are views showing a configuration for biasing the movable unit to the fixing unit in the shake correction device 201. FIG. 5A shows a state in which the upper structure 201A is on the movable unit side, and FIG. 5B shows a state in which the lower structure 201B is on the movable unit side.

In the example shown in FIG. 5A, an upper fixing unit 220A (fixing unit) and a lower fixing unit 220B (fixing unit) are bonded to each other by a fixing member 220C to form a fixing unit 220. That is, in this example, a movable unit 224 has the first magnet member 251, and the fixing unit 220 has the magnetic plate 261B (first member). The fixing member 220C can be configured with, for example, a shaft member for separating the upper fixing unit 220A and the lower fixing unit 220B in the +Z direction, and screws for fixing the shaft member.

In this example, the movable unit 224 (movable unit) includes the upper structure 201A and the imaging element 216. The imaging element 216 is fixed to the upper structure 201A by the holding member 241A and/or another member (not shown). In addition, the movable unit 224 is biased to the lower fixing unit 220B side by the magnetic spring having the above-described configuration, and is driven in the XY plane (in a plane intersecting (perpendicular to) the optical axis L) by the above-described VCM 229, whereby the image shake is corrected.

Meanwhile, in the example shown in FIG. 5B, an upper fixing unit 222A (fixing unit) and a lower fixing unit 222B (fixing unit) are bonded to each other by a fixing member 222C to form a fixing unit 222. That is, in this example, the fixing unit 222 has the first magnet member 251, and a movable unit 226 has the magnetic plate 261B (first member). Similarly to the fixing member 220C described above, the fixing member 222C can be configured with, for example, a shaft member for separating the upper fixing unit 222A and the lower fixing unit 222B in the +Z direction, and screws for fixing the shaft member.

In this example, the movable unit 226 (movable unit) includes the lower structure 201B and the imaging element 216. The imaging element 216 is fixed to the lower structure 201B by the holding member 241B and/or another member (not shown). In addition, the movable unit 226 is biased to the lower fixing unit 222B side by the magnetic spring having the above-described configuration, and is driven in the XY plane (in a plane intersecting the optical axis L) by the above-described VCM 229, whereby the image shake is corrected.

The configuration of “either the upper portion or the lower portion of the shake correction device 200 may be the movable unit or the fixing unit” described above for the example of FIGS. 5A and 5B can also be applied to other examples described below. In any case, the members of the shake correction device 201 have a shape and a dimension (for example, a shape and a dimension in which a portion of the imaging surface 216A is open in the +Z direction) that do not prevent the subject light from being incident on the imaging surface 216A.

### Configuration Example (Part 2) of Shake Correction Device

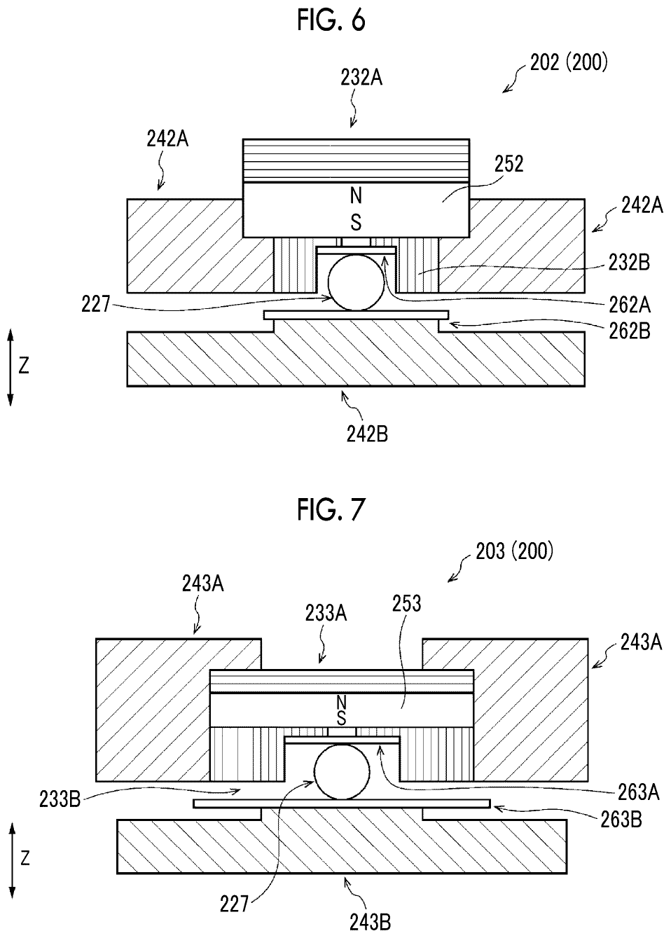

FIG. 6 is a sectional view showing a configuration of a shake correction device 202 (shake correction device 200; shake correction device, driving device). The vertical direction of the drawing is the +Z direction (a direction parallel to the optical axis L). In the shake correction device 202 shown in FIG. 6, a first magnet member 252 (first magnet member), a non-magnetic plate 262A (first non-magnetic member), and a magnetic plate 262B (first magnetic member, first member) are disposed with respect to the ball 227 (ball, first ball). The magnetic plate 262B is disposed on one side (lower side in FIG. 6) of the ball 227, and the non-magnetic plate 262A (first non-magnetic member) and the first magnet member 252 (first magnet member) are disposed in order, to face the magnetic plate 262B with the ball 227 interposed therebetween (on upper side in FIG. 6). In addition, the shake correction device 202 has the non-magnetic plate 262A (first non-magnetic member), the first magnet member 252 (first magnet member), and a first yoke 232A (yoke) in this order (from the lower side to the upper side in FIG. 6).

The magnetic plate 262B is held by a holding member 242B. In addition, the first yoke 232A holds the first magnet member 252, and a second yoke 232B holds the non-magnetic plate 262A.

The surface of the magnetic plate 262B on the upper side (+Z side or −Z side) in FIG. 6 is the ball receiving surface, and the ball 227 is in contact with the ball receiving surface. The ball 227 is also in contact with the lower side (−Z side or +Z side) surface of the non-magnetic plate 262A in FIG. 6.

In the shake correction device 202, as in the shake correction device 201 according to the configuration example (part 1) described above, the plate is not attracted to the magnet, and another space is not required as in a case where a coil spring is used. Further, by providing the non-magnetic plate 262A as the rolling surface, it is possible to satisfy the requirement for the rolling surface and to suppress the influence on the magnetic flux.

In addition, in the shake correction device 202, the dimension of the first magnet member 252 is larger than the dimension of the second yoke 232B in an XY in-plane direction (horizontal direction in FIG. 6), and the first magnet member 252 has a role as a flange. As a result, the shape of the second yoke 232B is simplified, the machinability is improved, and the portion where the magnetic flux leaks is reduced.

In the shake correction device 202, as in the shake correction device 201 described above, either the upper structure or the lower structure may be the movable unit or the fixing unit.

### Configuration Example (Part 3) of Shake Correction Device

FIG. 7 is a sectional view showing a configuration of a shake correction device 203 (shake correction device 200; shake correction device, driving device). The vertical direction of the drawing is the +Z direction (a direction parallel to the optical axis L). In the shake correction device 203 shown in FIG. 7, a first magnet member 253 (first magnet member), a non-magnetic plate 263A (first non-magnetic member), and a magnetic plate 263B (first magnetic member, first member) are disposed with respect to the ball 227 (ball, first ball). The magnetic plate 263B is disposed on one side (lower side in FIG. 7) of the ball 227, and the non-magnetic plate 263A (first non-magnetic member) and the first magnet member 253 (first magnet member) are disposed in order, to face the magnetic plate 263B with the ball 227 interposed therebetween (on upper side in FIG. 7). In addition, the shake correction device 203 has the non-magnetic plate 263A (first non-magnetic member), the first magnet member 253 (first magnet member), and a first yoke 233A (yoke) in this order (from the lower side to the upper side in FIG. 7).

The magnetic plate 263B is held by a holding member 243B. In addition, the first yoke 233A holds the first magnet member 253, and a second yoke 233B holds the non-magnetic plate 263A. A holding member 243A holds the first yoke 233A, the first magnet member 253, and the second yoke 233B.

The surface of the magnetic plate 263B on the upper side (+Z side or −Z side) in FIG. 7 is the ball receiving surface, and the ball 227 (first ball) is in contact with the ball receiving surface. The ball 227 is also in contact with the lower side (−Z side or +Z side) surface of the non-magnetic plate 263A in FIG. 7.

In the shake correction device 203, as in the shake correction devices according to the configuration examples (part 1) (part 2) described above, the plate is not attracted to the magnet, and another space is not required as in a case where a coil spring is used. Further, by providing the non-magnetic plate 263A as the rolling surface, it is possible to satisfy the requirement for the rolling surface and to suppress the influence on the magnetic flux.

In the shake correction device 203, as in the shake correction devices 201 and 202 described above, either the upper structure or the lower structure may be the movable unit or the fixing unit.

### Configuration Example (Part 4) of Shake Correction Device

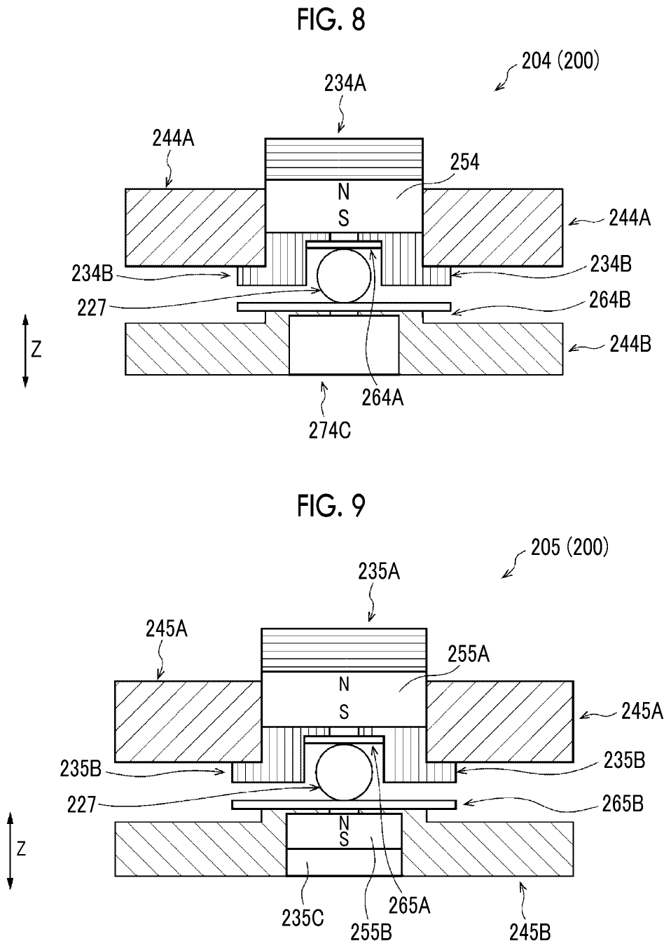

FIG. 8 is a sectional view showing a configuration of a shake correction device 204 (shake correction device 200; shake correction device, driving device). The vertical direction of the drawing is the +Z direction (a direction parallel to the optical axis L). In the shake correction device 204 shown in FIG. 8, a first magnet member 254 (first magnet member), a non-magnetic plate 264A (first non-magnetic member), and a magnetic plate 264B (first magnetic member, first member) are disposed with respect to the ball 227 (ball, first ball). The magnetic plate 264B is disposed on one side (lower side in FIG. 8) of the ball 227, and a magnetic member 274C (second magnetic member, first member) is disposed on a side opposite to the ball 227 with the magnetic plate 264B interposed therebetween.

Meanwhile, the non-magnetic plate 264A (first non-magnetic member) and the first magnet member 254 (first magnet member) are disposed in order, to face the magnetic plate 264B with the ball 227 interposed therebetween (on upper side in FIG. 8). In addition, the shake correction device 204 has the non-magnetic plate 264A (first non-magnetic member), the first magnet member 254 (first magnet member), and a first yoke 234A (yoke) in this order (from the lower side to the upper side in FIG. 8).

In addition, the magnetic plate 264B and the magnetic member 274C are held by a holding member 244B. In addition, the first yoke 234A holds the first magnet member 254, and a second yoke 234B holds the non-magnetic plate 264A. A holding member 244A holds the first yoke 234A, the first magnet member 254, and the second yoke 234B.

The surface of the magnetic plate 264B on the upper side (+Z side or −Z side) in FIG. 8 is the ball receiving surface, and the ball 227 (first ball) is in contact with the ball receiving surface. The ball 227 is also in contact with the lower side (−Z side or +Z side) surface of the non-magnetic plate 264A in FIG. 8.

In the shake correction device 204, as in the shake correction devices according to the configuration examples (part 1) to (part 3) described above, the plate is not attracted to the magnet, and another space is not required as in a case where a coil spring is used. Further, by providing the non-magnetic plate 264A as the rolling surface, it is possible to satisfy the requirement for the rolling surface and to suppress the influence on the magnetic flux.

In addition, since the magnetic member 274C is not in direct contact with the ball 227, the magnetic member 274C is not restricted by the constraint conditions (surface roughness, flatness, required size calculated from the movable amount, and the like) for the ball receiving surface, and the degree of freedom in design increases. Further, the biasing force can be increased by using the magnetic plate 264B and the magnetic member 274C.

Since the shake correction device 204 comprises the magnetic member 274C, a non-magnetic or weakly magnetic plate may be used instead of the magnetic plate 264B. In addition, in the shake correction device 204, as in the shake correction devices 201 to 203 described above, either the upper structure or the lower structure may be the movable unit or the fixing unit.

### Configuration Example (Part 5) of Shake Correction Device

FIG. 9 is a sectional view showing a configuration of a shake correction device 205 (shake correction device 200; shake correction device, driving device). The vertical direction of the drawing is the ±Z direction (a direction parallel to the optical axis L). In the shake correction device 205 shown in FIG. 9, a first magnet member 255A (first magnet member), a non-magnetic plate 265A (first non-magnetic member), and a non-magnetic plate 265B (first member, second non-magnetic member) are disposed with respect to the ball 227 (ball, first ball).

The non-magnetic plate 265B is disposed on one side (lower side in FIG. 9) of the ball 227, and a second magnet member 255B (first member, second magnet member) and a third yoke 235C are disposed on a side opposite to the ball 227 (lower side in FIG. 9) with the non-magnetic plate 265B interposed therebetween. Since the shake correction device 205 includes the second magnet member 255B, the biasing force can be secured even in a case where the non-magnetic plate 265B is disposed on the ball rolling surface.

Meanwhile, the non-magnetic plate 265A (first non-magnetic member) and the first magnet member 255A (first magnet member) are disposed in order, to face the non-magnetic plate 265B with the ball 227 interposed therebetween (on upper side in FIG. 9). In addition, the shake correction device 205 has the non-magnetic plate 265A (first non-magnetic member), the first magnet member 255A (first magnet member), and a first yoke 235A (yoke) in this order (from the lower side to the upper side in FIG. 9). In addition, the shake correction device 205 comprises a holding member 245A that holds the first magnet member 255A and the like, and a holding member 245B that holds the non-magnetic plate 265B, the second magnet member 255B, and the third yoke 235C.

With the shake correction device 205 having the above-described configuration, since the magnets are disposed on both sides (upper side and lower side in FIG. 9; ±Z direction) with the ball 227 interposed therebetween, the biasing force can be further increased. In addition, since the necessary biasing force may be secured by two magnets, the first magnet member 255A held by the holding member 245A may be reduced.

### Configuration Example (Part 6) of Shake Correction Device

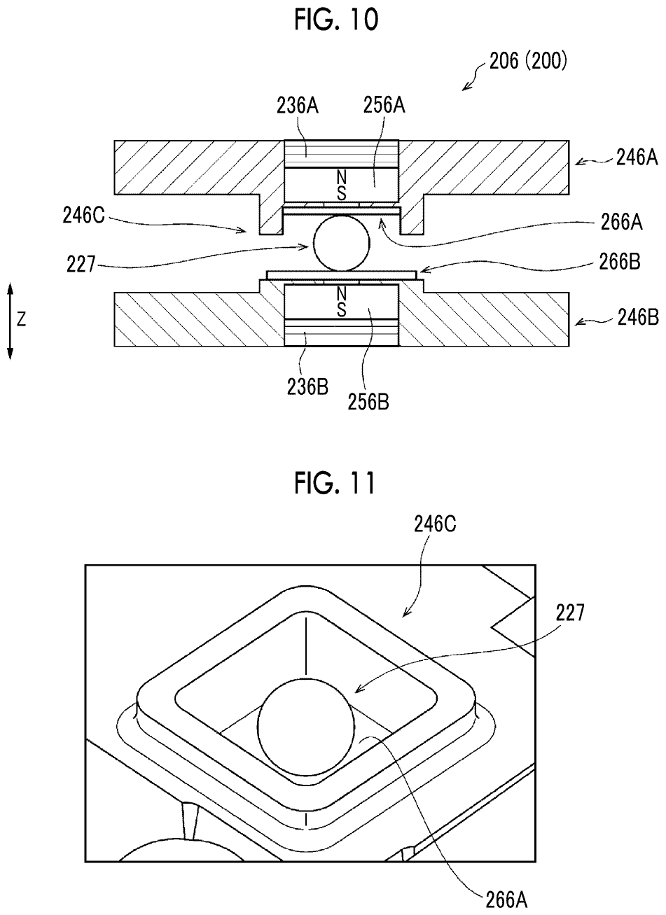

FIG. 10 is a sectional view showing a configuration of a shake correction device 206 (shake correction device 200; shake correction device, driving device). The vertical direction of the drawing is the +Z direction (a direction parallel to the optical axis L). In the shake correction device 206 shown in FIG. 10, a first magnet member 256A (first magnet member), a non-magnetic plate 266A (first non-magnetic member), and a non-magnetic plate 266B (first member, second non-magnetic member) are disposed with respect to the ball 227 (ball, first ball).

The non-magnetic plate 266B is disposed on one side (lower side in FIG. 10) of the ball 227, and a second magnet member 256B (first member, second magnet member) and a second yoke 236B are disposed on a side opposite to the ball 227 (lower side in FIG. 10) with the non-magnetic plate 266B interposed therebetween. Since the shake correction device 206 includes the second magnet member 256B, the biasing force can be secured even in a case where the non-magnetic plate 266B (the lower side of the ball 227 in FIG. 10) is disposed on the ball rolling surface.

Meanwhile, the non-magnetic plate 266A (first non-magnetic member) and the first magnet member 256A (first magnet member) are disposed in order, to face the non-magnetic plate 266B with the ball 227 interposed therebetween (on upper side in FIG. 10). In addition, the shake correction device 206 has the non-magnetic plate 266A (first non-magnetic member), the first magnet member 256A (first magnet member), and a first yoke 236A (yoke) in this order (from the lower side to the upper side in FIG. 10). In addition, the shake correction device 206 comprises a holding member 246A that holds the first magnet member 256A and the like, and a holding member 246B that holds the non-magnetic plate 266B, the second magnet member 256B, and the second yoke 236B.

As shown in FIGS. 10 and 11, the holding member 246A has a recessed ball holding part 246C (ball holding part) that holds the ball 227 (first ball). FIG. 11 is a perspective view (a state of being viewed from the lower side of FIG. 10) of the ball holding part 246C, and the ball holding part 246C surrounds the ball 227 and prevents the ball 227 from falling. As described above, in the shake correction device 200 according to the first embodiment, either the upper structure or the lower structure may be the movable unit or the fixing unit, and the ball holding part 246C may be provided in either the movable unit or the fixing unit.

With the shake correction device 206 having the above-described configuration, since the magnets are disposed on both sides (upper side and lower side in FIG. 10; +Z direction) with the ball 227 interposed therebetween, the biasing force can be further increased. In addition, since the necessary biasing force may be secured by two magnets, the first magnet member 256A held by the holding member 246A may be reduced. In addition, since there is no yoke in the lower portion of the first magnet member 256A, this portion can be reduced in size.

### Configuration Example (Part 7) of Shake Correction Device

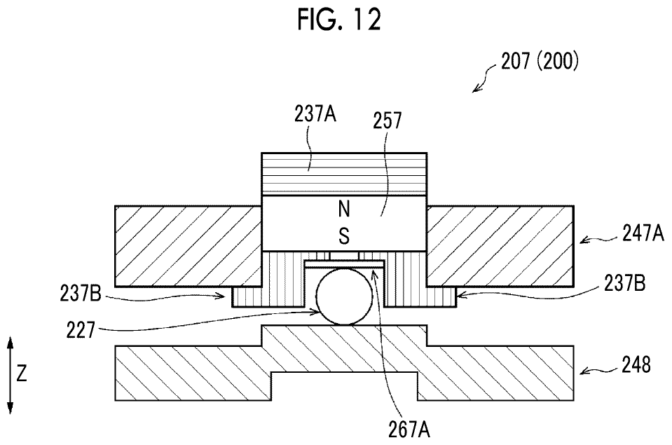

FIG. 12 is a sectional view showing a configuration of the shake correction device 207 (shake correction device 200; shake correction device, driving device). The vertical direction of the drawing is the ±Z direction (a direction parallel to the optical axis L). In the shake correction device 207 shown in FIG. 12, a first magnet member 257 (first magnet member), a non-magnetic plate 267A (first non-magnetic member), and a magnetic base 248 are disposed with respect to the ball 227 (ball, first ball).

In the shake correction device 207, the same configuration as the above-described shake correction device 201 (see FIG. 4) can be used except for the magnetic base 248, and the shake correction device 207 includes a first yoke 237A, a second yoke 237B, and a holding member 247A.

In the shake correction device 207, the holding member and the plate disposed below the ball 227 in another configuration example are formed of the same material to form the magnetic base 248. The magnetism of the magnetic base 248 is stronger than the magnetism of the non-magnetic plate 267A.

A partial region of the magnetic base 248 (a region that is a protrusion toward the upper side of FIG. 12) serves as a ball receiving surface (rolling surface) of the ball 227. The ball receiving surface can be formed integrally with the other portion of the magnetic base 248, for example, by press-working a member constituting the magnetic base 248. The press-working is, for example, half punching (referring to processing in which a height of about half a thickness of the target member is protruded without completely penetrating the member; sometimes referred to as half blanking, half penetration, punching, doweling, or the like). However, the height of the protruding portion is not limited to half the thickness of the member. Further, the ball receiving surface is preferably a surface formed by machining the protruding portion formed by half punching. As the machining, for example, processing to increase flatness can be performed by polishing.

In addition, a plate-shaped component formed of the same material as the magnetic base 248 may be fixed to the magnetic base 248 (holding member) by laser welding or the like to form the ball receiving surface.

With the shake correction device 207 having the above-described configuration, in addition to the same effects as in the other configuration examples, the holding member and the plate can be formed of the same member without being separated from each other while fulfilling the required functions with respect to the ball receiving surface. In addition, since the pulling by the magnetic force also depends on the thickness of the member, the biasing force can be increased by increasing the thickness of the ball receiving surface portion (the protruding portion of the magnetic base 248).

### Flow of Magnetic Flux in Shake Correction Device

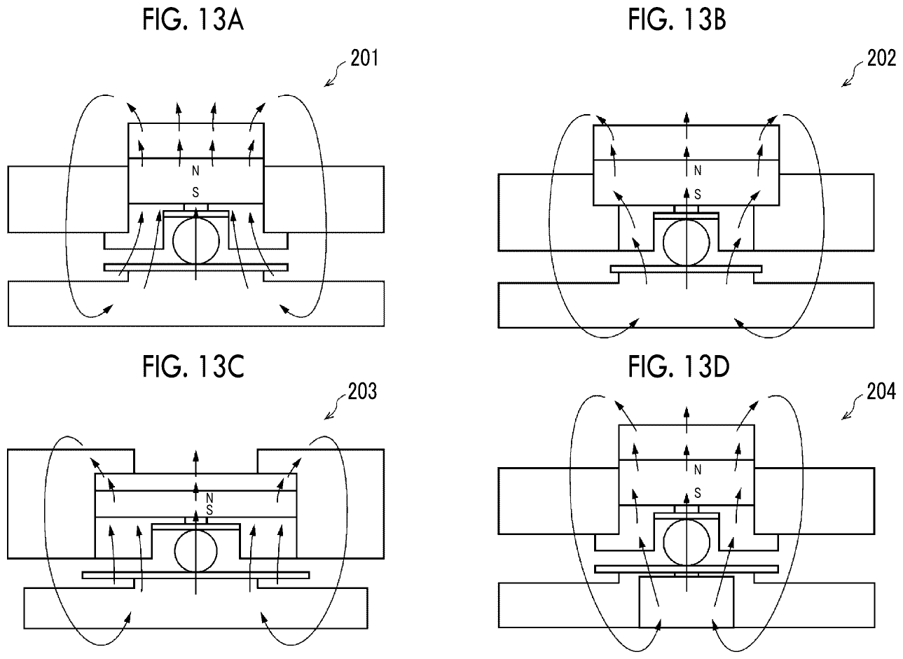

FIGS. 13A to 13D show a state of flow of the magnetic flux in the shake correction device 200 having the above-mentioned configuration. FIGS. 13A to 13D show states of the flow of the magnetic flux in the shake correction devices 201 to 204 according to the configuration examples (part 1) to (part 4), respectively. As shown in FIGS. 13A to 13D, in the shake correction device 200, the first magnet member (first magnet member 251 and the like), the first non-magnetic member (non-magnetic plate 261A and the like), and the first member (magnetic plate 261B and the like) including a magnetic member are disposed with respect to the ball 227 (first ball), and the first non-magnetic member and the first magnet member are disposed in order, to face the first member with the ball 227 interposed therebetween, whereby a magnetic circuit is configured by the first magnet member.

### Second Embodiment

In the first embodiment described above, an aspect in which the image shake is corrected by providing the shake correction device or the driving device inside the imaging apparatus main body 100 and driving the movable unit including the imaging element 216 has been described. However, in the present invention, the image shake may be corrected by driving the shake correction optical system held by the movable unit. Hereinafter, such a second embodiment will be described.

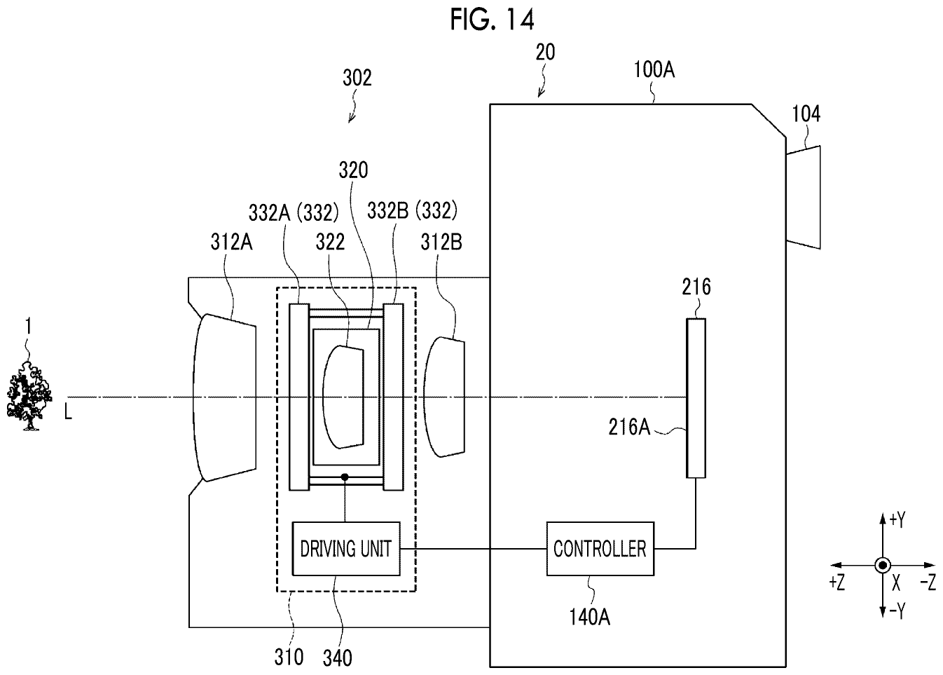

FIG. 14 is a view showing a schematic configuration of an imaging apparatus 20 according to a second embodiment. Hereinafter, the same reference numerals are given to the same configurations as those of the first embodiment, and the detailed description thereof will be omitted.

The imaging apparatus 20 (imaging apparatus) is a digital camera, and a lens device 302 (optical system, optical device) is mounted on an imaging apparatus main body 100A. The lens device 302 may be integrated with the imaging apparatus main body 100A or may be attachable and detachable to and from the imaging apparatus main body 100A. The lens device 302 comprises the lens group 312A and the lens group 312B, and has the optical axis L (optical axis). The lens device 302 forms an optical image of the subject 1 on the imaging element 216. The imaging apparatus main body 100A comprises the eyepiece portion 104, and an imager can place his/her eye on the eyepiece portion 104 to visually recognize the subject 1. The imaging apparatus 20 may have the stop 308 as in the first embodiment.

The imaging apparatus 20 comprises a shake correction device 310 (shake correction device) and a shake correction optical system 322 (shake correction optical system). The shake correction device 310 can employ the same configuration as the shake correction device 200 according to the first embodiment, and has a fixing unit 332 including a front fixing unit 332A and a rear fixing unit 332B, a movable unit 320, and a ball (at least one first ball) (not shown). The front fixing unit 332A and the rear fixing unit 332B can be fixed by a shaft or a screw in the same manner as described above for the first embodiment (see FIGS. 5A and 5B).

The shake correction optical system 322 can be configured by using one or more lenses, and is held by the movable unit of the shake correction device 310. A controller 140A can correct the image shake by controlling a driving unit 340 to drive the movable unit 320 including the shake correction optical system 322 in a plane intersecting the optical axis of the shake correction optical system 322. The term “in a plane intersecting an optical axis of the shake correction optical system” may refer to being in a plane perpendicular to the optical axis L, but the present invention is not limited thereto.

The driving unit 340 can be configured using a VCM in the same manner as the shake correction device 200 according to the first embodiment.

With the shake correction device 310 having the above-described configuration, as in the shake correction device 200 according to the first embodiment, the plate is not attracted to the magnet, and another space is not required as in a case where a coil spring is used. Further, by providing the non-magnetic plate and the like as the rolling surface, it is possible to satisfy the requirement for the rolling surface and to suppress the influence on the magnetic flux.

In the shake correction device 310, as in the shake correction device 200 described above, either the structure on the +Z side (for example, the holding member, the first yoke, the first magnet member, the non-magnetic plate, the second yoke, and the first ball) or the structure on the −Z side (for example, the magnetic plate and the holding member) may be the movable unit or the fixing unit.

In addition, the shake correction device according to the first aspect and the shake correction device according to the second aspect may be provided in one imaging apparatus.

Hereinbefore, the embodiment of the present invention has been described above, but the present invention is not limited to the above-described aspects, and various modifications can be made.

### EXPLANATION OF REFERENCES

1: subject
10: imaging apparatus
20: imaging apparatus
100: imaging apparatus main body
100A: imaging apparatus main body
104: eyepiece portion
122: image input controller
124: image processing unit
126: compression/expansion processing unit
128: video encoder
130: image monitor
138: operation unit
140: controller
140A: controller
147: flash memory
148: memory
152: media controller
154: memory card
158: driving unit
166: sensor
200: shake correction device
201: shake correction device
201A: upper structure
201B: lower structure
202: shake correction device
203: shake correction device
204: shake correction device
205: shake correction device
206: shake correction device
207: shake correction device
216: imaging element
216A: imaging surface
220: fixing unit
220A: upper fixing unit
220B: lower fixing unit
220C: fixing member
222: fixing unit
222A: upper fixing unit
222B: lower fixing unit
222C: fixing member
224: movable unit
226: movable unit
227: ball
231A: first yoke
231B: second yoke
232A: first yoke
232B: second yoke
233A: first yoke
233B: second yoke
234A: first yoke
234B: second yoke
235A: first yoke
235B: second yoke
235C: third yoke
236A: first yoke
236B: second yoke
237A: first yoke
237B: second yoke
241A: holding member
241B: holding member
242A: holding member
242B: holding member
243A: holding member
243B: holding member
244A: holding member
244B: holding member
245A: holding member
245B: holding member
246A: holding member
246B: holding member
246C: ball holding part
247A: holding member
248: magnetic base
250: ball receiving surface
251: first magnet member
252: first magnet member
253: first magnet member
254: first magnet member
255A: first magnet member
255B: second magnet member
256A: first magnet member
256B: second magnet member
257: first magnet member
261A: non-magnetic plate
261B: magnetic plate
262A: non-magnetic plate
262B: magnetic plate
263A: non-magnetic plate
263B: magnetic plate
264A: non-magnetic plate
264B: magnetic plate
265A: non-magnetic plate
265B: non-magnetic plate
266A: non-magnetic plate
266B: non-magnetic plate
267A: non-magnetic plate
274C: magnetic member
300: lens device
302: lens device
310: shake correction device
312A: lens group
312B: lens group
320: movable unit
322: shake correction optical system
332: fixing unit
332A: front fixing unit
332B: rear fixing unit
340: driving unit

What is claimed is:

1. A shake correction device comprising:
a fixing unit;
a movable unit; and
a plurality of balls disposed between the fixing unit and the movable unit,
wherein the movable unit is movable in contact with the plurality of balls,
a first magnet member, a first non-magnetic member, and a first member including a magnetic member are disposed with respect to a first ball that is at least one ball of the plurality of balls, and
the first non-magnetic member and the first magnet member are disposed in order, to face the first member with the first ball interposed therebetween.

2. The shake correction device according to claim 1,
wherein the first non-magnetic member, the first magnet member, and a yoke are provided in order.

3. The shake correction device according to claim 1,
wherein the fixing unit includes the first magnet member,
the first non-magnetic member is provided between the first magnet member and the first ball, and
the movable unit includes the first member.

4. The shake correction device according to claim 1,
wherein the movable unit includes the first magnet member,
the first non-magnetic member is provided between the first magnet member and the first ball, and
the fixing unit includes the first member.

5. The shake correction device according to claim 1,
wherein the first member includes a first magnetic member and a holding member that holds the first magnetic member, and
the first ball is in contact with the first magnetic member.

6. The shake correction device according to claim 5,
wherein the first non-magnetic member is disposed between the first magnet member and the first ball,
the first magnetic member is disposed to face the first non-magnetic member with the first ball interposed therebetween, and
a second magnetic member is provided on a side opposite to the first ball with respect to the first magnetic member.

7. The shake correction device according to claim 1,
wherein the first non-magnetic member is disposed between the first magnet member and the first ball, and
the first member includes
a second non-magnetic member disposed to face the first non-magnetic member with the first ball interposed therebetween, and
a second magnetic member disposed on a side opposite to the first ball with respect to the second non-magnetic member.

8. The shake correction device according to claim 7,
wherein the first member includes a second magnet member,
the second magnet member is disposed on a side opposite to the first ball with respect to the second non-magnetic member, and
the first ball is in contact with the second non-magnetic member.

9. The shake correction device according to claim 1,
wherein a ball holding part that holds the first ball is formed in the movable unit or the fixing unit.

10. An imaging apparatus comprising:
the shake correction device according to claim 1; and
an imaging element held by the movable unit,
wherein the movable unit is driven in a plane intersecting an optical axis of the imaging element to correct an image shake.

11. An imaging apparatus comprising:
an imaging element;
the shake correction device according to claim 1; and
a shake correction optical system held by the movable unit,
wherein the movable unit is driven in a plane intersecting an optical axis of the shake correction optical system to correct an image shake.

12. An optical device comprising:
the shake correction device according to claim 1; and
a shake correction optical system held by the movable unit,
wherein the movable unit is driven in a plane intersecting an optical axis of the shake correction optical system to correct an image shake.

13. A driving device comprising:
a fixing unit;
a movable unit; and
a ball disposed between the fixing unit and the movable unit,
wherein the movable unit is movable in contact with the ball,
a first magnet member, a first non-magnetic member, and a first member including a magnetic body are disposed with respect to the ball, and
the first non-magnetic member and the first magnet member are disposed in order, to face the first member with the ball interposed therebetween.
